(19) United States
(12) Patent Application Publication
(10) Pub. No.: US 2025/0044133 A1
(43) Pub. Date: Feb. 6, 2025

(54) METHOD FOR OPERATING A MAGNETIC INDUCTIVE FLOWMETER

(71) Applicant: Endress+Hauser Flowtec AG, Reinach (CH)

(72) Inventors: Markus Rüfenacht, Diepflingen (CH); Frank Schmalzried, Zolling (DE); Michael Burger, Seuzach (CH); Andrew Burg, Basel (CH)

(21) Appl. No.: 18/717,726

(22) PCT Filed: Nov. 22, 2022
(86) PCT No.: PCT/EP2022/082700

§ 371 Date: Jun. 7, 2024

(30) Foreign Application Priority Data
Dec. 15, 2021 (DE) 10 2021 133 189.7

(51) Int. Cl. G01F 1/58

(52) U.S. Cl. CPC G01F 1/588

(57) ABSTRACT

A method for operating a magnetic inductive flowmeter wherein the flowmeter includes a measuring tube for guiding a flowable medium; at least two measuring electrodes for detecting a measurement voltage which is dependent on the flow velocity and induced in the medium; and a magnetic field-generating device having a coil system with at least one coil for generating a magnetic field passing through the measuring tube, includes determining a deviation σ of a reactance of the coil system or a deviation σ of a variable dependent on the reactance of the coil system from a desired value. Also disclosed is a magnetic inductive flowmeter.

### METHOD FOR OPERATING A MAGNETIC INDUCTIVE FLOWMETER

The invention relates to a method for operating a magnetic-inductive flowmeter and to a magnetic-inductive flowmeter.

Magnetic-inductive flow meters are used for determining the flow rate and the volumetric flow of a flowing medium in a pipeline. A magnetic-inductive flowmeter has a magnet system that generates a magnetic field perpendicular to the direction of flow of the flowing medium. Single coils are typically used for this purpose. In order to realize a predominantly homogeneous magnetic field, pole shoes are additionally formed and attached such that the magnetic field lines run over the entire pipe cross-section substantially perpendicularly to the transverse axis or in parallel to the vertical axis of the measuring pipe. A measurement electrode pair attached to the lateral surface of the measuring tube senses an electrical measurement voltage or potential difference applied perpendicular to the flow direction and to the magnetic field, which arises when a conductive medium flows in the direction of flow when a magnetic field is applied. Since, according to Faraday's law of induction, the sensed measurement voltage depends on the velocity of the flowing medium, the flow rate Q_{V} or the flow velocity u and, with the aid of a known pipe cross-section, the volume flow rate \dot{V} can be determined from the induced measurement voltage U.

Magnetic-inductive flow meters are often used in process and automation engineering for fluids, as of an electrical conductivity of approximately 5 μS/cm. Corresponding flow meters are sold by the applicant in a wide variety of embodiments for various fields of application, for example under the name PROMAG.

The object of the invention is to provide a method for operating a magneto-inductive flowmeter with which influences of external magnetic fields on the flow measurement can be detected.

The object is achieved by the method according to claim 1 and the magnetic-inductive flowmeter according to claim 13.

The method according to the invention for operating a magnetic-inductive flowmeter, wherein the magnetic-inductive flowmeter comprises:
a measuring tube for guiding a flowable medium;
at least two measuring electrodes for detecting a flow velocity-dependent measurement voltage induced in the medium; and
a magnetic field-generating device for generating a magnetic field passing through the measuring tube,
   wherein the magnetic field-generating device has a coil system with at least one coil; characterized in that
   a deviation σ of a reactance of the coil system or a deviation σ of a variable dependent on the reactance of the coil system is determined from a desired value.

The magnetic-inductive flow meter according to the invention comprises:
a measuring tube for guiding a flowable medium;
at least two measuring electrodes for detecting a flow velocity-dependent measuring voltage induced in the medium; and
comprises a magnetic field-generating device for generating a magnetic field passing through the measuring tube,
   wherein the magnetic field generating device comprises a coil system with at least one coil; and
an operating, measuring and/or evaluation circuit; and is
   characterized in that
   the operating, measuring and/or evaluation circuit is set up to carry out the method according to the invention.

The reactance is a frequency-dependent variable which limits an alternating current by building up an alternating voltage and causes a temporal phase shift between voltage and current. In the complex alternating current calculation, reactance is the imaginary part of the complex impedance. The real part of the impedance is referred to as the active resistance. The magnitude of the impedance is referred to as the apparent resistance.

External magnetic fields influence the coil system of the magnetic-inductive flowmeter and cause measurement errors in the measured flow rate. According to the invention, the deviation of the reactance of the coil or of the coil system from a predetermined desired value is determined for the determination of the influence by external magnetic fields. The active resistance has a frequency range in which it is substantially insensitive to external magnetic fields. In the same frequency range, even the smallest influences by external magnetic fields lead to deviations of several percent in the reactance. Temperature-dependent measurements were able to show that thermal influences in the same frequency range have effects substantially exclusively on the active resistance.

Advantageous embodiment of the invention are the subject matter of the dependent claims.

In one embodiment, an, in particular multi-frequency, excitation signal is provided at the coil system,

wherein the excitation signal comprises a pulse sequence at one frequency, at least two pulse sequences each at least one frequency, and/or at least one sinusoidal signal.

The excitation signal is used to operate the coil system and to generate a magnetic field penetrating the measuring tube with a constant magnetic field strength over time. The excitation signal can be a time-varying coil current that is applied in a controlled manner or a time-varying coil voltage.

The pulse sequences are preferably applied to the coil system in two successive measurement phases. It is self-evident that the measurement phases in which the pulse sequences are respectively applied do not have to follow one another directly, and that the pulse sequences do not have to be synchronized with the switchover of the magnetic field. Rather, the pulse sequences can be applied both synchronously and asynchronously with the tapping of the induced measuring voltage by means of the measuring electrodes. The pulse sequence is, for example, a sequence of square-wave pulses. However, other types of pulse sequences, such as sinusoidal pulses or pseudo-noise, may also be used in conjunction with the present invention.

In one embodiment, a measurement signal is determined at the coil system,

wherein a transformation, in particular, an integral transformation and/or a Fourier analysis and/or a Z-transformation of a temporal section of the excitation signal and the measurement signal or a temporal section of a variable dependent on the excitation signal and/or measurement signal takes place.

In the case that the excitation signal is a coil voltage, the measurement signal corresponds to a coil current. In the case that the excitation signal is a coil current, the measurement signal corresponds to a coil voltage.

To determine the reactance, it is advantageous to transform a temporal section of the excitation signal and the measurement signal or a variable dependent on the excitation signal and/or measurement signal from the time domain to the frequency domain in order to obtain the frequency spectrum associated with the measurement signal and/or excitation signal or the variable dependent on the excitation signal and/or measurement signal. Furthermore, changes in the reactance in the frequency spectrum are determined to determine the deviation σ. In this case, the determination of the deviation σ can include the reactance over the entire spectrum or only selected frequencies of the reactance, which are referred to below as the monitoring frequency f₀.

For determining the frequency spectrum of the reactance, either the excitation signal and the measurement signal are first transformed into a frequency spectrum and then the reactance is determined from the quotient of both signals, or a time signal of the reactance is first formed from the excitation signal and the measurement signal and then transformed into a frequency spectrum.

Suitable methods for transforming are, for example, an integral transformation and a Fourier analysis, wherein the Fourier analysis includes the Fourier series method, the continuous Fourier transformation, the discrete Fourier transformation and the Fourier transformation for discrete-time signals.

One embodiment provides that the reactance or the variable dependent on the reactance is determined by means of an amplitude of the transform for a monitoring frequency f₀ or by means of the amplitudes of the transforms of at least two monitoring frequencies f_{0,1}, f_{0,2}.

One embodiment provides that a change in the reactance or the variable dependent on the reactance is determined as a function of the amplitude of the transform for a monitoring frequency f₀.

One embodiment provides that the one monitoring frequency f₀ or the at least two monitoring frequencies f_{0,1}, f_{0,2} are selected from a monitoring frequency range f for which the following applies: 0.1 Hz≤f≤10 kHz, in particular 1≤f≤1,000 Hz and preferably f≤250 Hz.

Surprisingly, it has been found that a spectral line of a monitoring frequency f₀ with low frequency values (f₀≤10 kHz, in particular ≤1 kHz, and preferably ≤250 Hz) contains sufficient power to be used to determine deviations a caused by external magnetic fields.

One embodiment provides that the reactance or the variable dependent on the reactance is determined from an extrapolation which originates from an extrapolation taking into account the at least two monitoring frequencies f_{0,1}, f_{0,2} for a frequency f_{Extra} which is smaller than a lower limit of the monitoring frequency range f.

This is particularly advantageous for magnetic-inductive flowmeters with large nominal diameters (≤DN150), as the external magnetic fields or aging of the magnetic field-generating device can still be detected very accurately despite high eddy currents.

Furthermore, the embodiment enables a reduction of temperature effects. A temperature-related deviation of 1% was reduced to 0.3% by taking the extrapolated values into account.

In one embodiment, the excitation signal corresponds to a coil exciter signal,

wherein the coil exciter signal has at least one measurement phase in which a coil current is substantially constant and in which a measurement of the induced measuring voltage takes place,

wherein the coil excitation signal has a transient phase between two, in particular successive, measurement phases, in which a coil current and/or a coil current direction in the coil system changes.

The coil excitation signal corresponds to the signals that are applied to the coil system in conventional magnetic-inductive flowmeters to generate a constant magnetic field during the measuring phase. In the measurement phase, the measuring voltage induced in the medium is determined at the measuring electrodes. The function of the coil exciter signal is to generate a temporally constant magnetic field during a measurement phase.

A coil exciter signal usually has a substantially pulsed coil voltage or a pulsed coil current with a clocked sign. There is always a range in which the coil current and/or the coil voltage is constant. There are also embodiments in which the coil exciter signal comprises two or more pulsed coil voltages, wherein one is used to reduce a decay duration of the coil current and thus accelerate the generation of the temporally constant magnetic field.

In one embodiment, the excitation signal corresponds to a coil exciter signal and an additionally impressed diagnostic signal,

wherein the coil exciter signal has at least one measurement phase in which a coil current is substantially constant and in which a measurement of the induced measuring voltage takes place,

wherein the coil exciter signal and the diagnostic signal each comprise a pulse sequence at one frequency, at least two pulse sequences each at least one frequency, and/or at least one sinusoidal signal,

wherein the at least one frequency of the diagnostic signal differs from the at least one frequency of the diagnostic signal, and/or an amplitude of the diagnostic signal differs from an amplitude of the coil exciter signal.

It is also advantageous if the excitation signal does not consist exclusively of the coil excitation signal, but also includes a diagnostic signal. The diagnostic signal comprises a pulse sequence at one frequency, at least two pulse sequences each at least one frequency, and/or at least one sinusoidal signal. This also includes a so-called pseudo-noise with a large number of frequencies, i.e., a frequency spectrum.

The excitation signal can have a phase between the coil exciter signals, in which phase the diagnostic signal is applied to the coil system. For this purpose, the period between the pulsed coil voltages can be increased or the coil excitation signal can be briefly suspended.

One embodiment provides that in the event that the reactance or the variable dependent on the reactance is within a first reactance range, in particular, that the reactance or the variable dependent on the reactance is smaller than the desired value, the presence of an external magnetic field is assumed and that this is optionally output.

The first reactance range is preferably below the desired value or a lower tolerance limit for the desired value. If the present magnetic field or the determined apparent self-inductance of the magnetic-inductive flowmeter is lower than a reference value, then this results in a lower reactance relative to the desired value. The apparent self-inductance of the magnetic-inductive flowmeter comprises the contribution of the apparent inductance of the magnetic field-generating device—in particular the at least one coil, the at least one coil core and the field feedback—the influence of eddy currents and the influence of external magnetic fields.

One embodiment provides that in the event that the reactance or the variable dependent on the reactance is within a second reactance range, in particular, that the reactance or the variable dependent on the reactance is greater than the desired value, the presence of magnetic field-generating components in the medium or a coating containing magnetic field-generating components is assumed and that this is optionally output.

The second reactance range differs from the first reactance range. The second reactance range is preferably above the desired value or an upper tolerance limit for the desired value. If the present magnetic field or the determined apparent self-inductance of the magnetic-inductive flowmeter is higher than a reference value, then this results in a higher reactance relative to the desired value.

One embodiment provides for a change in the deviation σ over time to be determined,

wherein a degree of ageing of the coil system is determined as a function of the temporal change and optionally output.

One embodiment provides that the desired value of the reactance or the variable dependent on the reactance describes the reactance or the variable dependent on the reactance in the adjusted state.

One embodiment provides that the variable dependent on the reactance comprises the impedance, in particular the apparent self-inductance, of the coil system.

One embodiment provides that in the event that the deviation σ exceeds a limit value during commissioning of the magnetic-inductive flowmeter, mechanical damage or manipulation of the coil system is assumed and that this is optionally output.

The invention is explained in greater detail with reference to the following figures. In the figures:

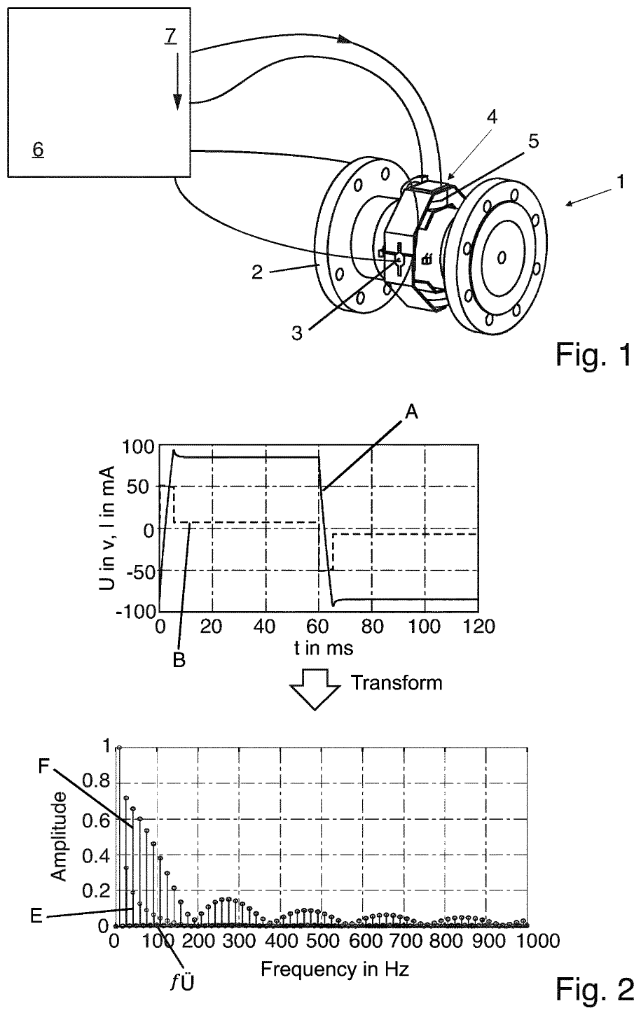

FIG. 1 is a perspective view of a cross-section through a magnetic-inductive flow meter according to the invention;

FIG. 2: is an embodiment of an excitation signal B and a measurement signal A in the time range and in the corresponding frequency range;

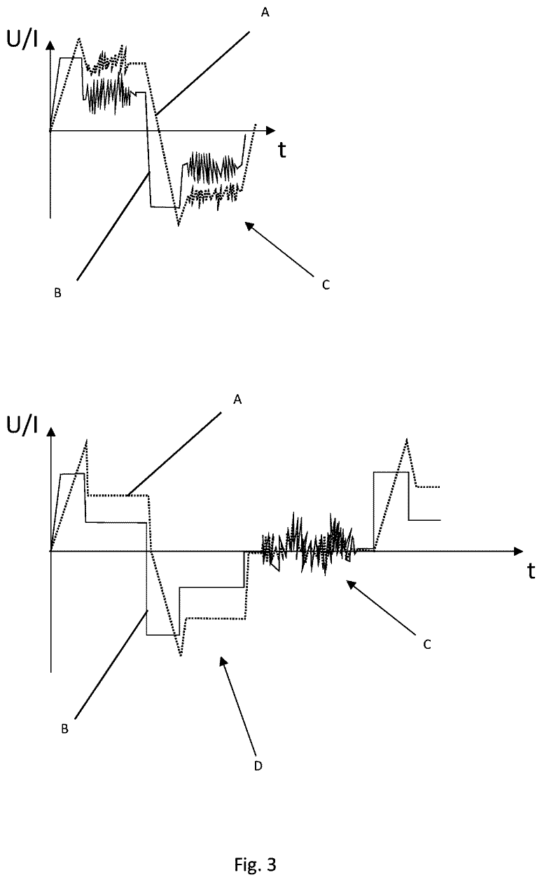

FIG. 3: are two further embodiments of the excitation signal B and measurement signal A in the time range; and

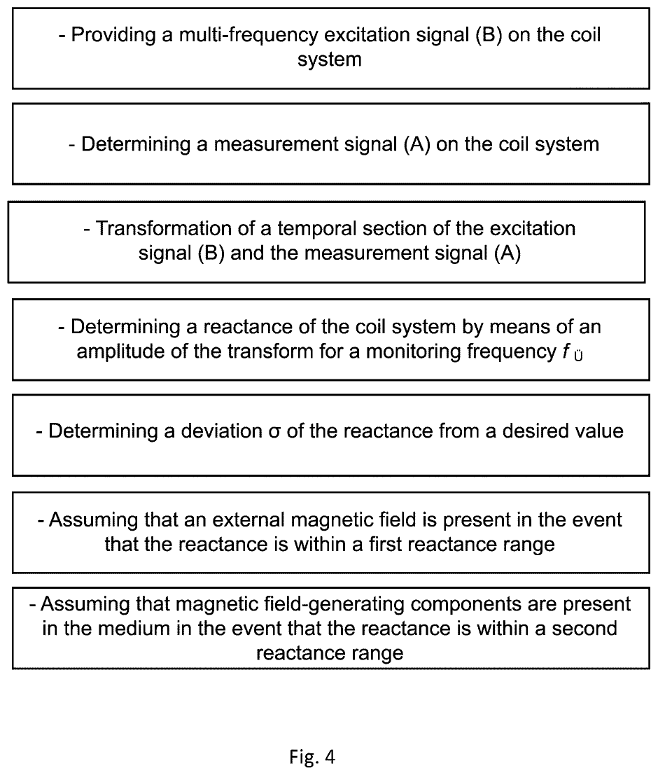

FIG. 4: is an evaluation curve according to the invention.

The structure and measuring principle of the magnetic-induction flowmeter 1 is known in principle (see FIG. 1). A medium having an electrical conductivity is conducted through a measuring tube 2. The measuring tube 2 usually comprises a metallic tube with an electrically insulating liner or a plastic or ceramic tube. A magnetic field-generating device 4 is attached in such a way that the magnetic field lines are oriented substantially perpendicularly to a longitudinal direction defined by the measuring tube axis. A saddle coil or a pole shoe with a mounted coil 5 is preferably suitable as the magnetic-field-generating device 4. When the magnetic field is applied, a potential distribution is produced in the measuring tube 2, which is sensed by two measurement electrodes 3 attached opposite each other on the inner wall of the measuring tube 2. In general, two measurement electrodes 3 are used, which measurement electrodes are arranged diametrically and form an electrode axis that runs perpendicular to an axis of symmetry of the magnetic field lines and of the longitudinal axis of the measuring tube 2. On the basis of the measured measurement voltage and taking into account the magnetic flux density, the flow rate of the medium can be determined and, taking into account the cross-sectional area of the tube, the volumetric flow rate can be determined. If the density of the medium is known, it will be possible to determine the mass flow rate.

The magnetic field built up by means of the coil and pole-shoe arrangement is generated by a clocked direct current of alternating flow direction. An operating circuit 6 is connected to the two coils 5 and is configured to apply an excitation voltage with a characteristic curve to the coil system, with which the coil current or the coil voltage is regulated.

Advantageous embodiments of the characteristic curve of the excitation signals B are shown in FIGS. 1 and 2. The polarity reversal of the voltage source ensures a stable zero point and renders the measurement insensitive to influences from multi-phase substances, inhomogeneities in the liquid or low conductivity. A measurement and/or evaluation circuit 7 reads the voltage applied to the measurement electrodes 3 and outputs the flow rate and/or the calculated volume flow rate and/or the mass flow rate of the medium. In the cross-section, shown in FIG. 1, of a magneto-inductive flowmeter 1 the measurement electrodes 3 are in direct contact with the medium. However, coupling can also take place capacitively. According to the invention, the measurement and/or evaluation circuit 7 is additionally configured to determine a measurement signal A at the coil system. The measurement signal A comprises the coil voltage actually present at the coil system and/or the coil current through the coil system.

According to the invention, the measurement and/or evaluation circuit is furthermore configured to transform the excitation signal B and the measurement signal A or a variable dependent on the excitation signal B and measurement signal A into a frequency spectrum, and to determine therefrom a deviation σ of the reactance from a desired value and to correct the determined measured flow rate value as a function of the determined deviation σ.

A display unit (not shown) outputs the determined deviation σ or a variable dependent on the determined deviation σ. Alternatively, a message or a warning can be output if these deviate from the stored setpoint value or setpoint interval. The reference value is determined by means of a mathematical model, calibration method and/or simulation program. However, this is not sufficient in particular in applications in the drinking water sector. The measurement and/or evaluation circuit 7 is therefore configured to correct the measured measurement voltage or a measured flow rate dependent on the measurement voltage by the determined deviation σ. The deviation σ is not necessarily determined over the entire frequency spectrum or for all individual frequencies, but for a selected monitoring frequency f₀.

FIG. 2 shows an embodiment of an excitation signal B and a measurement signal A in the time domain, and the resulting frequency spectra E and F in the frequency domain. According to the embodiment, the excitation signal B comprises a coil voltage, and the measurement signal A comprises a coil current. The coil voltage comprises two clocked pulses with different pulse amplitudes and pulse widths. Such an excitation signal B corresponds to a typical coil exciter signal D.

After the transformation of a temporal section of the measurement signal and the excitation signal, a frequency spectrum with discrete frequencies is obtained in each case. In the case of deviations from a desired value, influences by external magnetic fields can then be deduced from the frequency-dependent reactance. The measurement and/or evaluation unit is configured to monitor the change in the reactance for a set monitoring frequency f₀. According to the embodiment shown, the monitoring frequency is approximately 100 Hz.

FIG. 3 shows two embodiments of the excitation signal B and of the measurement signal A. In both embodiments, the excitation signal B comprises a coil voltage, and the measurement signal A comprises a coil current. Both embodiments differ from the embodiment of FIG. 1 in that, in addition to the coil exciter signal D, a diagnostic signal C is applied to the coil system. The two embodiments shown differ in how the diagnostic signal C is related to the coil exciter signal D.

The first of the two embodiments shows a characteristic excitation signal B to which the diagnostic signal C is applied in addition to the coil excitation signal D. The excitation signal B is a superposition of the coil excitation signal D and the diagnostic signal C. This means that coil excitation signal D and diagnostic signal C are superimposed. The measurement signal A depends on the excitation signal B and therefore shows a reaction of the coil system to the diagnostic signal C. The diagnostic signal C must be temporally offset with the coil exciter signal D such that the diagnostic signal C does not extend into the measurement phase. The reaction of the measurement signal A to the excitation signal B is sensitive to external magnetic fields.

Therefore, the frequency and/or the amplitude of the diagnostic signal C is defined independently of the coil exciter signal D such that external influences can be resolved with the measurement and/or evaluation circuit.

The second of the two embodiments also shows a characteristic excitation signal B in which the diagnostic signal C is applied in addition to the coil exciter signal D. However, the coil exciter signal D is interrupted for a time period in which the diagnostic signal C is applied. The diagnostic signal C and the coil exciter signal D thus alternate.

FIG. 4 shows a process sequence according to the invention with the process steps:
Providing a multi-frequency coil excitation signal (D) on the coil system.

The coil excitation signal (D) consists of a coil voltage comprising at least two pulse sequences, each with a frequency. Details of the coil excitation signal (D) are shown in FIGS. 2 and 3.
Determining a measurement signal (A) on the coil system.

The measurement signal (A) is a coil current which, due to the applied coil voltage, flows through the magnetic field-generating device, in particular, through the at least one coil, and is measured by means of a measuring circuit.
Transformation of a temporal section of the coil excitation signal (D) and the measurement signal (A) using Fourier analysis.
Determining a reactance of the coil system by means of an amplitude of the transform for a monitoring frequency f₀.

The one monitoring frequency f₀ or the at least two monitoring frequencies f_{0,1}, f_{0,2} are selected from a monitoring frequency range f for which it applies that f≤250 Hz.

Alternatively, the reactance of the mean of the amplitudes of the transforms of at least two monitoring frequencies f_{0,1}, f_{0,2} can be determined. In this case, the reactance is determined from an extrapolation that originates from an extrapolation taking into account the at least two monitoring frequencies f_{0,1}, f_{0,2} for a frequency f_{Extra}. The frequency f_{Extra} is smaller than a lower limit of the monitoring frequency range f. An example of the frequency f_{Extra} can be 0 Hz. This procedure is particularly advantageous for measuring tubes with large nominal diameters—and therefore necessarily also large eddy currents—and for magnetic-inductive flowmeters with temperature-sensitive magnetic field-generating devices.

Alternatively, a variable dependent on the reactance can be determined instead of the reactance. For example, a current apparent self-induction can be determined and monitored for the detection of external magnetic fields or ageing of the magnetic field-generating device.
Determining a deviation σ of the reactance from a desired value.
Assuming that an external magnetic field is present in the event that the reactance or the deviation σ is within a first reactance range or a first reactance deviation range and outputting a warning message.
Assuming that magnetic field-generating components are present in the medium in the event that the reactance or the deviation σ is within a second reactance range or a second reactance deviation range and outputting a warning message.

Alternatively or additionally, a temporal change in the deviation σ can be determined and a degree of ageing of the coil system can be determined as a function of the temporal change.

### LIST OF REFERENCE SIGNS

1 Magnetic-inductive flowmeter
2 Measuring tube
3 Measuring electrode
4 Magnetic field-generating device
5 Coil
6 Operating circuit
7 Measurement and/or evaluation circuit
A Measurement signal
B Excitation signal
C Diagnostic signal
D Coil excitation signal
E Frequency spectrum of the measurement signal
F Frequency spectrum of the excitation signal
f₀ Monitoring frequency
f_{0,1} First monitoring frequency
f_{0,2} Second monitoring frequency

1-13. (canceled)

14. A method for operating a magnetic-inductive flowmeter, wherein the magnetic-inductive flowmeter includes:
a measuring tube for guiding a flowable medium;
at least two measuring electrodes for detecting a flow velocity-dependent measuring voltage induced in the medium; and
a magnetic field-generating device having a coil system with at least one coil for generating a magnetic field passing through the measuring tube, the method comprising:
determining a deviation σ of a reactance of the coil system or a deviation σ of a variable dependent on the reactance of the coil system from a desired value.

15. The method according to claim 14,
wherein an excitation signal is provided at the coil system,
wherein the excitation signal includes a pulse sequence at one frequency, at least two pulse sequences each at least one frequency, and/or at least one sinusoidal signal.

16. The method according to claim 14, further comprising:
determining a measurement signal at the coil system; and
performing a transformation of a temporal section of the excitation signal and the measurement signal or a temporal section of a variable dependent on the excitation signal and/or measurement signal.

17. The method according to claim 16,
wherein the transformation is an integral transformation, a Fourier analysis, and/or a Z-transformation.

18. The method according to claim 16,
wherein the reactance or the variable dependent on the reactance is determined via an amplitude of the transform for a monitoring frequency f₀ or via the amplitudes of the transforms of at least two monitoring frequencies f_{0,1}, f_{0,2}.

19. The method according to claim 18,
wherein a change in the reactance or the variable dependent on the reactance is determined as a function of the amplitude of the transform for a monitoring frequency f₀.

20. The method according to claim 18,
wherein the one monitoring frequency f₀ or the at least two monitoring frequencies f_{0,1}, f_{0,2} are selected from a monitoring frequency range f for which the following applies: 0.1 Hz≤f≤10 kHz.

21. The method according to claim 20,
wherein the reactance or the variable dependent on the reactance is determined from an extrapolation which originates from an extrapolation taking into account the at least two monitoring frequencies f_{0,1}, f_{0,2} for a frequency f_{Extra} which is smaller than a lower limit of the monitoring frequency range f.

22. The method according to claim 21,
wherein the excitation signal corresponds to a coil exciter signal,
wherein the coil exciter signal has at least one measurement phase in which a coil current is constant and in which a measurement of the induced measuring voltage takes place, and
wherein the coil excitation signal has a transient phase between two measurement phases in which a coil current and/or a coil current direction in the coil system changes.

23. The method according to claim 22,
wherein the excitation signal corresponds to a coil exciter signal and an additionally impressed diagnostic signal,
wherein the coil exciter signal has at least one measurement phase in which a coil current is constant and in which a measurement of the induced measuring voltage takes place,
wherein the coil exciter signal and the diagnostic signal each include a pulse sequence at one frequency, at least two pulse sequences each at at least one frequency, and/or at least one sinusoidal signal, and
wherein the at least one frequency of the diagnostic signal differs from the at least one frequency of the diagnostic signal, and/or an amplitude of the diagnostic signal differs from an amplitude of the coil exciter signal.

24. The method according to claim 14, further comprising:
determining a presence of an external magnetic field when the reactance or the variable dependent on the reactance lies within a first reactance range that is smaller than the desired value.

25. The method according to claim 14, further comprising:
determining a presence of magnetic field-generating components or a coating containing magnetic field-generating components in the medium when the reactance or the variable dependent on the reactance lies within a second reactance range that is greater than the desired value.

26. The method according to claim 14, further comprising:
determining a temporal change in the deviation σ; and
determining a degree of ageing of the coil system as a function of the temporal change.

27. A magnetic-inductive flow meter, comprising:
a measuring tube for guiding a flowable medium;
at least two measuring electrodes for detecting a flow velocity-dependent measuring voltage induced in the medium;
a magnetic field-generating device having a coil system with at least one coil for generating a magnetic field passing through the measuring tube; and
an operating, measurement, and/or evaluation circuit,
wherein the operating, measurement, and/or evaluation circuit is configured to determine a deviation σ of a reactance of the coil system or a deviation σ of a variable dependent on the reactance of the coil system from a desired value.
